(19) United States
(12) Patent Application Publication
(10) Pub. No.: US 2020/0234241 A1
(43) Pub. Date: Jul. 23, 2020

(54) Systems and Methods for Automated SDLC, Portfolio, Program and Project Management

(71) Applicant: GalaxE.Solutions, Inc., Somerset, NJ (US)

(72) Inventors: Dheeraj MISRA, Somerset, NJ (US); Sandipan GANGOPADHYAY, Somerset, NJ (US); Tim BRYAN, Somerset, NJ (US)

(21) Appl. No.: 16/746,442

(22) Filed: Jan. 17, 2020

Related U.S. Application Data
(60) Provisional application No. 62/794,376, filed on Jan. 18, 2019.

(51) Int. Cl. G06Q 10/10; G06Q 10/06; G06F 8/20

(52) U.S. Cl. CPC G06Q 10/103; G06F 8/20; G06Q 10/0633; G06Q 10/06313

(57) ABSTRACT

A system for enterprise-level software project management includes a system inventory database coupled to one or more enterprise IT systems configured for enterprise-level software development. The system also includes a project builder configured to build an enterprise-level software development project based on received user intent data and IT environment data retrieved from the system inventory database. The software development projects includes a multi-tier hierarchy that provides hierarchal linking between a plurality of project tiers of the software development project. The system also includes a project management engine configured to enable a user to manage the software development project via an interactive dashboard. Management of the software development project is based on the multi-tier hierarchy.

### CROSS-REFERENCE TO RELATED APPLICATIONS

This application claims the benefit of U.S. Provisional Application No. 62/794,376, filed on Jan. 18, 2019, the entire contents of which are hereby incorporated by reference.

### BACKGROUND OF THE INVENTION

Typically, in large organizations, enterprise-level software development relies on a combination of various disparate technology platforms across different tiers of the enterprise IT architecture. These intricate interdependencies between platforms are usually not well documented, nor well understood, due to the complex nature of the integrations between applications and systems, as well as the lack of a common framework for managing software development at the program and project levels, in addition to the work breakdown structure, activity and resource levels. The effective and efficient management of enterprise-level software development becomes more challenging when multiple departments with varying processes, needs and technologies are participating in an enterprise-level program or project.

As such, despite the availability of multiple tools across the enterprise IT environment, the lack of a common framework that brings the information and processes relying on the those tools together creates a situation where multiple processes are created, different skill sets are needed, and non-standardization is promulgated. This results in the waste of premium bandwidth in managing administrative details, such as, for example, creating non-standardized reports, which are often a financial drain and may not accurately track to the project. The result is that inaccuracies are reported to business level decision makers of the enterprise. Other difficulties and challenges result, including, for example, high licensing costs of the developed software solution, lack of trained resources, complexity in managing the software solution in-house, and high costs of consulting resources required for customization.

The typical approaches to managing enterprise-level software development include the use of high level systems, such as, Clarity, Microsoft Project Server, Primavera, etc., with a combination of manual effort and spreadsheets. These approaches, however, suffer from the aforementioned drawbacks.

In order to overcome the above challenges and to efficiently and effectively establish, change and/or otherwise provide for the management of software development lifecycle (SDLC), portfolio, program and project management, the enterprise should be able to easily and quickly identify cross-dependencies among SDLC, portfolio, program and project elements across the architectural tiers of the enterprise IT environment involved.

In that regard, a system and method for automated SDLC, portfolio, program and project management is disclosed herein, which overcomes these and other shortcomings of prior systems and/or methods. Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure use terminology and acronyms that may not be familiar to the layperson, those skilled in the art will be familiar with the terminology and acronyms used herein.

### BRIEF DESCRIPTION OF THE DRAWINGS

FIG. 1 illustrates an example system in accordance with one or more aspects of the disclosure.

FIG. 2 illustrates a diagram of the architecture in accordance with one or more aspects of the disclosure.

FIG. 3 illustrates a flow diagram of an algorithm used by the architecture of FIG. 2 in accordance with one or more aspects of the disclosure.

### DETAILED DESCRIPTION OF EMBODIMENTS OF THE INVENTION

The disclosure is directed to automated SDLC, portfolio, program and project management systems and methods, and more particularly to more efficient management of SDLCs, portfolios, programs and projects through the building and maintenance of such SDLCs, portfolios, programs and projects end-to-end traceability.

A system and method for automated SDLC, portfolio, program and project management is described herein. A software development project is built from provided user intent data and based on retrieved IT environment information. The project includes metadata associating aspects of the project with each other, as well as with and across other aspects across and among tiers of a multi-tier hierarchy, which are also cross-referenced.

Accordingly, in at least one aspect, there is the ability to perform canonical and customized searches of project aspects, and generate reports that can show assist in the management of the project across technologies and enterprise departments. To that end, manual identification of cross-dependencies and interpretation of data, for instance, may be eliminated.

The present disclosure provides a number of benefits and/or advantages over prior methods of SDLC, portfolio, program and project management. For example, end-to-end traceability is available which may help eliminate the draw-backs of traditional project management systems, such as the failure to identify many critical components and dependencies, the duplication of such components, erroneous manual entries and work-arounds, and inconsistent documentation.

An additional benefit and/or advantage, for example, may be an increased audit readiness, both for internal and external compliance, due to a reduction in the amount of time spent correlating information with a high degree of accuracy. The end-to-end traceability provided by the software design project intrinsically provides such correlation, which in turn promotes efficiency and reduces errors during auditing.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment.

Furthermore, the particular features, structures, or characteristics may be combined in any suitable manner on one or more embodiments without limitation. The term “or” as used herein is to be interpreted as inclusive or meaning any one or any combination.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, for brevity sake well-known methods, procedures, components, and circuits have not been described in detail.

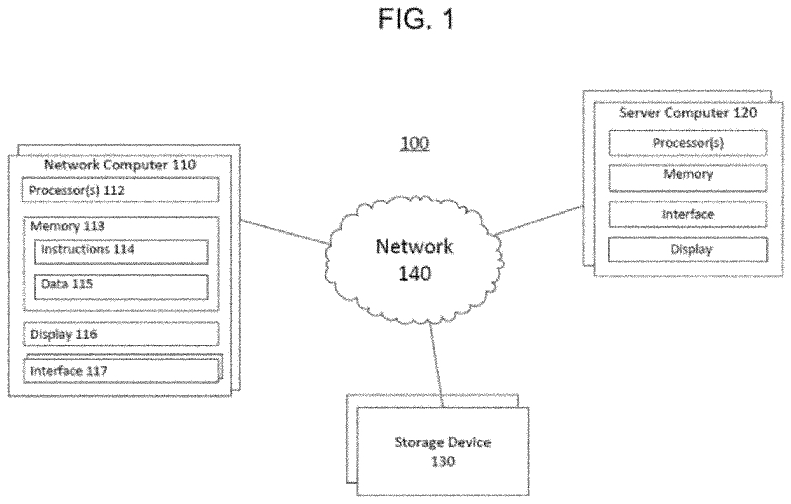

FIG. 1 illustrates an example system 100 in accordance with one or more aspects of the disclosure. System 100 may include a plurality of computers and/or computing devices, such as, network computer 110, server computer 120, and storage device 130. By way of example only, network computer 110 is connected to network 140 and may include different types of components associated with a computer, such as one or more processors 112, memory 113, instructions 114, data 115, display 116, and an interface 117. The network computer 110 may be mobile (e.g., laptop computer, tablet computer, smartphone, PDA, etc.) or stationary (e.g., desktop computer, etc.). Similarly, server computer 120 may also include one or more processors, memory, interface, and/or display and may be configured to communicate with other computer devices on network 140.

The processor 112 of network computer 110 may instruct the components thereof to perform various tasks based on the processing of information and/or data that may have been previously stored or have been received, such as instructions 114 and/or data 115 stored in memory 113. The processor 112 may be a standard processor, such as a central processing unit (CPU), or may be a dedicated processor, such as an application-specific integrated circuit (ASIC) or a field programmable gate array (FPGA).

Memory 113 stores at least instructions 114 and/or data 115 that can be accessed by processor 112. For example, memory 113 may be hardware capable of storing information accessible by the processor, such as a ROM, RAM, hard-drive, CD-ROM, DVD, write-capable, read-only, etc. The set of instructions may be included in software that can be implemented on the network computer 110 and should be noted that the terms “instructions,” “steps,” “algorithm,” and “programs” may be used interchangeably. Data 115 can be retrieved, manipulated or stored by the processor 112 in accordance with the set of instructions 114 or other sets of executable instructions. The data 115 may be stored as a collection of data.

The display 116 may be any type of device capable of communicating data to a user, such as a liquid-crystal display (“LCD”) screen, a plasma screen, etc. Interface 117 allow a user to communicate with the network computer 110 and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

The server computer 120 (and additional server computers) may be rack mounted on a network equipment rack and/or located, for instance, in a data center. In one example, the server computer 120 may use the network 140 to serve the requests of programs executed on network computer 110 and/or storage device 130.

The storage device 130 illustrated in FIG. 1 may be configured to store large quantities of data and/or information. For example, the storage device 130 may be a collection of storage components, or a mixed collection of storage components, such as ROM, RAM, hard-drives, solid-state drives, removable drives, network storage, virtual memory, cache, registers, etc. The storage device 130 may also be configured so that the network computer 110 and/or server computer 120 may access it via the network 140.

The network 140 may be any type of network, wired or wireless, configured to facilitate the communication and transmission of data, instructions, etc. from one component to another component of the network. For example, the network 140 may be a local area network (LAN) (e.g., Ethernet or other IEEE 802.03 LAN technologies), Wi-Fi (e.g., IEEE 802.11 standards, wide area network (WAN), virtual private network (VPN), global area network (GAN), any combination thereof, or any other type of network.

It is to be understood that the network configuration illustrated in FIG. 1 serves only as an example and is thus not limited thereto. System 100, for instance, may include numerous other components connected to network 140, include more than one of each network component (as shown by the cascaded blocks), and network 140 may be connected to other networks.

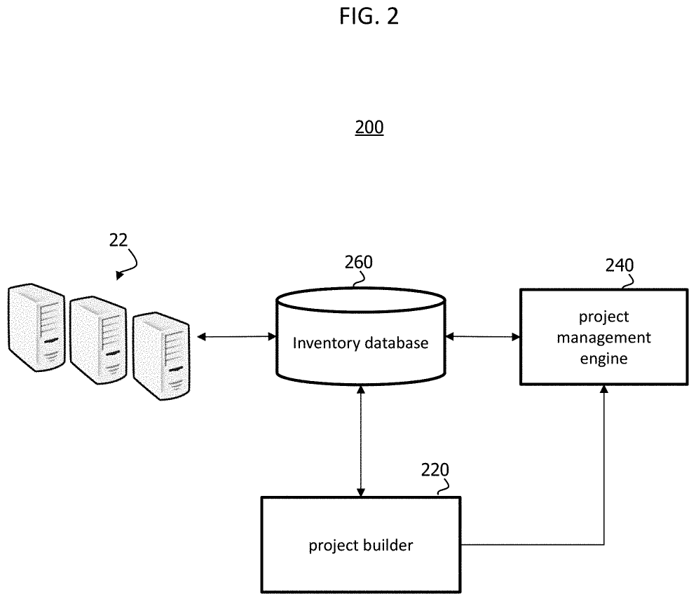

FIG. 2 illustrates one embodiment of an exemplary architecture 200 for SDLC, portfolio, program and/or project management, which is herein described in terms of project management, although one of ordinary skill in the art will appreciate that the principles described herein may be similarly applied to SDLC, portfolio and/or program management.

The architecture 200 shown in FIG. 2 includes a project builder 220, a project management engine 240 a system inventory database 260 coupled to one or more systems 22 of an enterprise IT environment utilized in enterprise-level software development. The dashboard (not shown) may enable the user to interact with the architecture 200, so as to effectuate the functions described herein, as appropriate. One example of the operation of the system architecture shown in FIG. 2 is as follows.

User intent data with respect to the design and configuration of the project is provided to the project builder 220, via the dashboard, which builds the project in accordance with the user intent and based on IT environment information retrieved from the system inventory database 260. The user intent data may include data regarding business goals, technical requirements, and other rules governing a software development project. In some aspects, the user intent data is gathered via configurable questionnaires presented to the user. Machine learning artificial intelligence may be utilized to design and/or modify the questionnaires based on the user intent data previously provided and/or IT environment information, which may include test results from the testing of the software solution, the regulatory audit process, questionnaires, responses and other information from previous software development projects, etc. The user intent data may include data related to return on investment and benefits, prioritization and plan phase approvals, capacity/resource management, and value capture considerations of the software development project.

The IT environment information includes information relating to the IT environment relevant to enterprise-level software development projects. For example, such information, may include information about the availability of resources, such as, for example, software development tools and technologies across enterprise systems 22. These tools may include software development tools and technologies such as, for example, Clarity, MS Project Server, MS Project, Clarity Integrations, MS Project Server Integrations, MS Project Integrations, MS Project Plan Generators, SharePoint Integrations, etc. Resource information may also include information regarding human and materials resources, such as, for example, project progress indicators, work hours contributed, etc., and project templates. The IT environment information may be formatted according to various formats, such as, for example, XML, Excel, Claims System, and Requirements Doc. formats, and may be provided from systems 22 across internal departments and groups of the enterprise.

Based on the user intent and IT environment information, the project builder 220 defines the software development project, which includes a multi-tier hierarchal linking between various tiers of the project. Those tiers include business level, portfolio level, program level, project level, work breakdown structure (WBS) level, activity level and resource level tiers, each of which describe the software development project in terms of those tiers. For example, the business level tier provides linking of the captured business intent across and among the other tiers.

In at least one aspect, the project builder 220 translates the captured user intent data into a determination of a project classification based on the captured user intent, according to which relevant IT environment information, such as, for example, the availability of relevant tools and resources, within the system inventory database 260, may be retrieved and utilized in defining the software development project. An effort estimation based on calculators may also be utilized in defining the project. The project may also be defined in accordance with stage gate management techniques.

Once the software development project is defined, the project manager 260, in conjunction with the interactive dashboard, provides for the automated and semi-automated management of the project by utilizing the multi-tier hierarchy. In at least one aspect, the project manager 260 may automatically maintain the project status across and among the different tiers of the multi-tier hierarchy. Maintaining project status may include maintaining control metrics, such as: on time total project performance, percent of projects started and completed as of planned phase data, percent of projects started from approved portfolio lists, percent of projects completed at or below budget, percent in internal versus external cost by department, customer satisfaction by release, percent re-work effort, earned business value, percent scope implementation, total project budge variance, percent of risks/issues addressed within SLA, average time to resolve issues/risks, number of change requests, percent of change requests due to missed requirements and/or new requirements, etc. These and other metrics may be tracked across all projects because of the inherent end-to-end traceability of the project.

Moreover, the project manager 260 may be used to generate project reports for particular end users, which may be a series of reports on the various tiers associated with the project. These reports may provide detailed analysis of the tiers and their overall impact and/or implications on the project. For example, reports may include project progress reports, portfolio dashboards and reports, and effort based plans. In one example, reports may be in digital format and may be utilized on one or more GUIs by the end user, customers, and/or consumers.

The project manager 260 may also provide access to the project and its hierarchy, which may be depended on by other network computers in designing software solutions in accordance with the project. The project manager 240 may thus further be utilized for end-to-end tracing of aspects of the project across the one or more systems and technologies based on the multi-tier hierarchy.

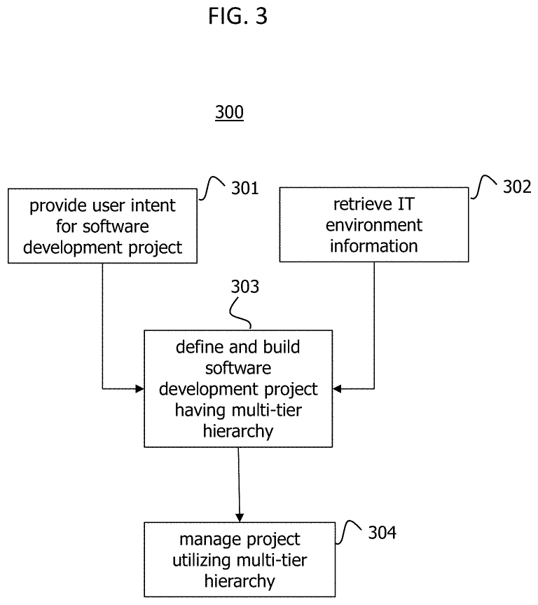

As described above, FIG. 3 illustrates a flow-diagram 300 of an algorithm used by the architecture of FIG. 2 in accordance with one or more aspects of the disclosure. As shown, at step 301, user intent data is provided to the project builder 220. At step 302, the project builder 220 retrieves IT environment information from the system inventory database 260. At step 303, the project builder 220 defines and builds the project in accordance with the provided user intent and based on the retrieved IT environment information, which project build includes a multi-tier hierarchal linking between various tiers of the project. At step 304, the project manager 240 provides for the automated and semi-automated management of the project by utilizing the multi-tier hierarchy.

In further aspects, the generation of standardized reports across technology platforms, departments, etc. is provided for, which accounts for multiple methodologies, such as, for example, Waterfall and Agile, resulting in on-time, on-budget, and low risk delivery. Right-sizing of the project as well as managing change requests, FPOs, issues and risks, and support and training is also facilitated.

In further aspects, the ability to record time and other resource expenditures at the activity level, and to trace such resource expenditures between assigned ownership, and planned-effort-and-spend versus actual-effort-and-spend at more granular levels is provided. Accordingly, more control over the management of the software design project across and among disparate technologies and enterprise departments may be had.

In still further aspects, the project management systems and methods provide for standardized project demand intake from business and IT groups within the enterprise, automates the linkage of business case capture into project execution, and facilitates the searching of previous projects to continue to build, review and reuse standards for similar projects. It further provides a rules-driven guided intent and information capture, which enables the use of validation rules at the earliest point in time of the information capture. In addition, dynamic regulatory and CSV requirements may be captured and incorporated, and LOE and costing details may be dynamically generated.

In still further aspects, a standard PMO platform for all IT project schedules and resource demand is facilitated by the automated project information load to appropriate tools across the enterprise. The use of deliverable templates promotes consistency, and the utilization of automated alerts to catch issues/risks, provides standard, optimized, lean project performance reporting for projects. Project scheduling best practices and quality audits are thereby facilitated.

Moreover, aspects of the project management systems and methods mitigate delays and improve risk detection by promoting the identification of defects before deployment, eliminating the need to revisit applications later, and also achieving consistent quality. The ability to get a full, clear and consistent understanding of business needs before software development starts, with a complete list of lifecycle deliverables, is also provided. This facilitates rapid speed to market. In addition, a repeatable process is enabled by incorporating industry standards and introducing a simplified, more scalable and standardized process in line with industry best practices and measurable against business objectives. Further, end-to-end lifecycle of IT systems, starting from determination of applicable regulations to operational support is covered by enforcing process adherence through the project execution and stage gate assessments.

In a further aspect of the disclosure, as discussed herein, an easy-to-use, intuitive GUI is provided that includes the dashboard that permits a user to view end-to-end traceability of the project, and to view and navigate between tiers of the project. Links may be provided within the GUI that can be clicked by a user in order to navigate directly between and among tiers.

While certain exemplary embodiments have been described and shown in the accompanying drawings, it is to be understood that such embodiments are merely illustrative of and not restrictive on the broad inventions, and that this inventions not be limited to the specific constructions and arrangements shown and described, since various other modifications may occur to those ordinarily skilled in the art.

1. A system for enterprise-level software project management, the system comprising:
a system inventory database coupled to one or more enterprise IT systems configured for enterprise-level software development;
a project builder configured to build an enterprise-level software development project based on received user intent data and IT environment data retrieved from the system inventory database, wherein the software development projects includes a multi-tier hierarchy that provides hierarchal linking between a plurality of project tiers of the software development project; and
a project management engine configured to enable a user to manage the software development project via an interactive dashboard, wherein management of the software development project is based on the multi-tier hierarchy.

2. The system of claim 1, wherein the project tiers include: business level, portfolio level, program level, project level, work breakdown structure (WBS) level, activity level and resource level tiers.

3. The system of claim 1, wherein the project builder is further configured to determine relevant IT environment data based on the user intent, and to retrieve the relevant IT environment data from the system inventory database.

4. The system of claim 1, wherein the project manager is further configured to automatically maintain one or more project statuses across and among the project tiers based on the multi-tier hierarchy.

5. The system of claim 4, wherein automatically maintaining the one or more project statuses includes automatically maintaining one or more control metrics.

6. The system of claim 1, wherein the project manager is further configured to generate project reports based on the multi-tier hierarchy.

7. The system of claim 1, wherein the interactive dashboard facilitates visual navigation of the multi-tier hierarchy by the user.

8. A method for enterprise-level software project management, the method comprising:
retrieving user intent data and IT environment data from a system inventory database coupled to one or more enterprise IT systems configured for enterprise-level software development;
building, via a project builder, an enterprise-level software development project based on the retrieved user intent data and IT environment data, wherein the software development projects includes a multi-tier hierarchy that provides hierarchal linking between a plurality of project tiers of the software development project; and
managing, via an interactive dashboard supported by a project management engine, the software development project, wherein management of the software development project is based on the multi-tier hierarchy.

9. The method of claim 8, wherein the project tiers include: business level, portfolio level, program level, project level, work breakdown structure (WBS) level, activity level and resource level tiers.

10. The method of claim 8, wherein retrieving user intent data and IT environment data includes:
determining, via the project builder, relevant IT environment data based on the user intent; and
retrieving the relevant IT environment data from the system inventory database.

11. The method of claim 8, further comprising:
automatically maintaining, via the project manager, one or more project statuses across and among the project tiers based on the multi-tier hierarchy.

12. The method of claim 11, wherein automatically maintaining the one or more project statuses includes automatically maintaining one or more control metrics.

13. The method of claim 8, further comprising:
generating, via the project manager, one or more project reports based on the multi-tier hierarchy.

14. The method of claim 8, wherein the interactive dashboard facilitates visual navigation of the multi-tier hierarchy by the user.
